(19) United States
(12) Patent Application Publication
(10) Pub. No.: US 2022/0264324 A1
(43) Pub. Date: Aug. 18, 2022

(54) APPARATUS AND METHOD OF DETERMINING QUASI-CO-LOCATION CONFIGURATION

(71) Applicant: GUANGDONG OPPO MOBILE TELECOMMUNICATIONS CORP., LTD., Dongguan (CN)

(72) Inventor: Li Guo, Allen, TX (US)

(73) Assignee: GUANGDONG OPPO MOBILE TELECOMMUNICATIONS CORP., LTD., Dongguan (CN)

(21) Appl. No.: 17/736,269

(22) Filed: May 4, 2022

Related U.S. Application Data
(63) Continuation of application No. PCT/CN2020/124270, filed on Oct. 28, 2020.
(60) Provisional application No. 62/934,322, filed on Nov. 12, 2019.

(51) Int. Cl. H04W 16/28; H04W 72/04; H04W 72/12; H04W 74/08

(52) U.S. Cl. CPC H04W 16/28; H04W 74/0841; H04W 72/1263; H04W 72/044

(57) ABSTRACT

An apparatus and a method of determining a quasi-co-location (QCL) configuration are provided. The method performed by a user equipment (UE) includes for a periodic resource, if a QCL configuration is not provided to a user equipment (UE) by a base station, the UE derives a QCL assumption for the periodic resource. This can solve issues in the prior art, provide a clear UE behavior of processing a periodic resource, provide a good communication performance, and/or provide high reliability.

### CROSS REFERENCE TO RELATED APPLICATIONS

This application is a continuation of International Patent Application No. PCT/CN2020/124270, filed on Oct. 28, 2020, which claims priority to U.S. provisional application No. 62/934,322, filed on Nov. 12, 2019, the contents of both applications are hereby incorporated by reference in their entireties.

### BACKGROUND OF DISCLOSURE

### 1. Field of Disclosure

The present disclosure relates to the field of communication systems, and more particularly, to an apparatus and a method of determining a quasi-co-location (QCL) configuration, which can provide a good communication performance and/or high reliability.

### 2. Description of Related Art

In a current specification, a quasi-co-location (QCL) configuration to a periodic resource is not mandatory but is optional. For a periodic resource without the QCL configuration, a network such as a base station can apply any different transmission (Tx) beams and can even change the Tx beam on the transmission in the same resource from time to time. Thus, a UE behavior of receiving that resource is ambiguous. The UE does not know whether it can use the same Rx beam to receive multiple transmission instances of the same resource. The UE does not know whether it can average a measurement of multiple transmission instances of the same resource.

Therefore, there is a need for an apparatus and a method of determining a quasi-co-location (QCL) configuration, which can solve issues in the prior art, provide a clear UE behavior of processing a periodic resource, provide a good communication performance, and/or provide high reliability.

### SUMMARY

An object of the present disclosure is to propose an apparatus and a method of determining a quasi-co-location (QCL) configuration, which can solve issues in the prior art, provide a clear UE behavior of processing a periodic resource, provide a good communication performance, and/or provide high reliability.

In a first aspect of the present disclosure, a method of determining a quasi-co-location (QCL) configuration by a user equipment includes for a periodic resource, if a QCL configuration is not provided to a user equipment (UE) by a base station, the UE derives a QCL assumption for the periodic resource.

In a second aspect of the present disclosure, a user equipment (UE) includes a memory, a transceiver, and a processor coupled to the memory and the transceiver. For a periodic resource, if a quasi-co-location (QCL) configuration is not provided to the processor by a base station, the processor derives a QCL assumption for the periodic resource.

In a third aspect of the present disclosure, a method of determining a quasi-co-location (QCL) configuration by a base station includes for a periodic resource, if a QCL configuration is not provided to a user equipment (UE) by a base station, the base station controls the UE to derive a QCL assumption for the periodic resource.

In a fourth aspect of the present disclosure, a base station includes a memory, a transceiver, and a processor coupled to the memory and the transceiver. For a periodic resource, if a quasi-co-location (QCL) configuration is not provided to a user equipment (UE) by the transceiver, the processor controls the UE to derive a QCL assumption for the periodic resource.

In a fifth aspect of the present disclosure, a non-transitory machine-readable storage medium has stored thereon instructions that, when executed by a computer, cause the computer to perform the above method.

In a sixth aspect of the present disclosure, a chip includes a processor, configured to call and run a computer program stored in a memory, to cause a device in which the chip is installed to execute the above method.

In a seventh aspect of the present disclosure, a computer readable storage medium, in which a computer program is stored, causes a computer to execute the above method.

In an eighth aspect of the present disclosure, a computer program product includes a computer program, and the computer program causes a computer to execute the above method.

In a ninth aspect of the present disclosure, a computer program causes a computer to execute the above method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field can obtain other figures according to these figures without paying the premise.

FIG. 1 illustrates a transmitter block diagram for a downlink (DL) or uplink (UL) transmission.

FIG. 2 illustrates a receiver block diagram for receiving a DL or UL transmission.

FIG. 3 is a block diagram of a user equipment (UE) and a base station of determining a quasi-co-location (QCL) configuration according to an embodiment of the present disclosure.

FIG. 4 is a flowchart illustrating a method of determining a quasi-co-location (QCL) configuration by a UE according to an embodiment of the present disclosure.

FIG. 5 is a flowchart illustrating a method of determining a quasi-co-location (QCL) configuration by a base station according to an embodiment of the present disclosure.

FIG. 6 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Fifth-generation (5G) wireless systems are generally a multi-beam based system in a frequency range 2 (FR2) ranging from 24.25 GHz to 52.6 GHz, where multiplex transmit (Tx) and receive (Rx) analog beams are employed by a base station (BS) and/or a user equipment (UE) to combat a large path loss in a high frequency band. In a high frequency band system, for example, mmWave systems, the BS and the UE are deployed with large number of antennas, so that a large gain beamforming can be used to defeat the large path loss and signal blockage. Due to the hardware limitation and cost, the BS and the UE might only be equipped with a limited number of transmission and reception units (TXRUs). Therefore, hybrid beamforming mechanisms can be utilized in both BS and UE. To get the best link quality between the BS and the UE, the BS and the UE need to align analog beam directions for a particular downlink or uplink transmission. For a downlink transmission, the BS and the UE need to find the best pair of a BS Tx beam and a UE Rx beam while for an uplink transmission, the BS and the UE need to find the best pair of the UE Tx beam and the BS Rx beam.

For a communication between one UE and a BS, the BS and the UE need to determine which Tx and Rx beam are going to be used. When one UE moves, the beams used by the BS and the UE for communication might change. In 3GPP 5G specification, the following functions are defined to support such multi-beam-based operation.

At an operation associated with beam measurement and reporting, in this function, the UE can measure one or multiple Tx beams of the BS and then the UE can select the best Tx beam and report his selection to the BS. By measuring the Tx beams of the BS, the UE can also measure one or more different Rx beams and then select the best Rx beam for one particular Tx beam of the BS. In this function, the gNB can also measure one or multiple Tx beams of the UE and then select the best Tx beam of the UE for an uplink transmission. To support measuring Tx beams of the BS, the BS can transmit multiple reference signal (RS) resources and then configures the UE to measure the RS resources. Then, the UE can report an index of one or more selected RS resources that are selected based on some measure metric, for example, a layer 1 reference signal received power (L1-RSRP). To support measuring Tx beams of the UE used for an uplink transmission, the BS can configure the UE to transmit one or more uplink RS resources, for example, sounding reference signal (SRS) resources, and then the BS can measure the RS resources. The BS can figure out which Tx beam of the UE is the best for the uplink transmission based on measuring, for example, L1-RSRP of the RS resources.

At an operation associated with beam indication, for a downlink transmission, the BS can indicate the UE of which Tx beam of the BS is used to transmit, so that the UE can use proper Rx beam to receive the downlink transmission. For a physical downlink control channel (PDCCH) transmission, the BS can indicate an identify (ID) of one Tx beam of the BS to the UE. For a physical sidelink discovery channel (PSDCH) transmission, the BS can use downlink control information (DCI) in a PDCCH to indicate the ID of one Tx beam that is used to transmit a corresponding PDSCH. For an uplink transmission from the UE, the BS can also indicate the UE of which Tx beam of the UE to be used. For example, for a physical uplink control channel (PUCCH) transmission, the UE uses a Tx beam that is indicated by the BS through a configuration of spatial relation information. For an SRS transmission, the UE uses the Tx beam that is indicated by the BS through the configuration of spatial relation information. For a physical uplink shared channel (PUSCH) transmission, the UE uses a Tx beam that indicated by an information element contained in a scheduling DCI.

At an operation associated with beam switch, this function is used by the BS to switch a Tx beam used for a downlink or uplink transmission. This function is useful when the Tx beam used for transmission currently is out of date due to for example a movement of the UE. When the BS finds a Tx beam currently used for a downlink transmission is not good or the BS finds another Tx beam that is better than the current Tx beam, the BS can send signaling to the UE to inform a change of Tx beam. Similarly, the BS can switch an uplink Tx beam of the UE used to transmit some uplink transmission.

In a communication system, such as a new radio (NR) system, DL signals can include control signaling conveying DCI through a PDCCH, data signals conveying information packet through a PDSCH and some types of reference signals. The DCI can indicate information of how the PDSCH is transmitted, including for example resource allocation and transmission parameters for the PDSCH. The BS can transmit one or more types of reference signals for different purposes, including a demodulation reference symbol (DM-RS) that is transmitted along with the PDSCH and can be used by the UE to demodulate the PDSCH, a channel state information reference signal (CSI-RS) that can be used by the UE to measure BS's Tx beam or CSI of a downlink channel between the BS and the UE, a phase tracking reference signal (PT-RS) that is also transmitted along with a PDSCH and can be used by the UE to estimate a phase noise caused by imperfection in a radio frequency (RF) part in a transmitter and a receiver and then compensate it when decoding the PDSCH. In NR, DL resource allocation for PDCCH, PDSCH, and reference signals is performed in a unit of orthogonal frequency division multiplexing (OFDM) symbols and a group of physical resource blocks (PRBs). Each PRB contains a few resource elements (REs), for example 12 REs, in a frequency domain. A transmission bandwidth (BW) of one downlink transmission consists of frequency resource unit called as resource blocks (RBs) and each RB consists of a few subcarriers or REs, for example, 12 subcarriers or 12 REs.

UL signals transmitted by the UE to the BS can include data signals conveying data packet through a PUSCH, uplink control signals conveying UL control information (UCI) which can be transmitted in the PUSCH or a PUCCH, and UL reference signals. The UCI can carry a schedule request (SR) used by the UE to request an uplink transmission resource, a hybrid automatic repeat request acknowledgement (HARQ-ACK) feedback for a PDSCH transmission or a channel state information (CSI) report. The UE can transmit one or more types of uplink reference signals for different purposes, including DM-RS that is transmitted along with a PUSCH transmission and can be used by the BS to demodulate the PUSCH, PT-RS that is also transmitted along with a PUSCH and can be used by the BS to estimate the phase noise caused by imperfection in RF parts and the BS then can compensate it when decoding PUSCH, and SRS signals that are used by the BS to measure one or more UE Tx beams or CSI of the uplink channel between the UE and the BS. Similarly, UL resource allocation for PUSCH, PUCCH, and UL reference signal is also performed in a unit of symbols and a group of PRBs.

A transmission interval for DL or UL channels/signals is referred to as a slot and each slot contains a few, for example 14, symbols in time domain. In a NR system, the duration of one slot can be 1, 0.5, 0.25 or 0.123 millisecond, for the subcarrier spacing 15 KHz, 30 KHz, 60 KHz, and 120 KHz, respectively. NR systems support flexible numerologies and an embodiment can choose proper OFDM subcarrier spacing based on the deployment scenario and service requirement. In the NR system, DL and UL transmission can use different numerologies.

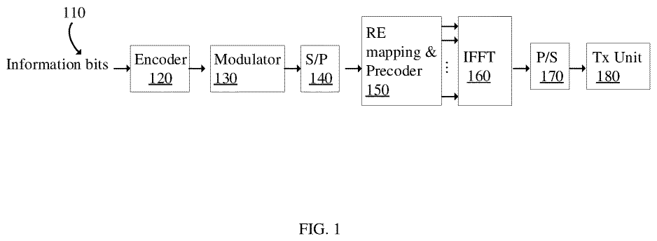

FIG. 1 illustrates a transmitter block diagram for a DL or UL transmission. An embodiment of the transmitter block illustrated in FIG. 1 is for illustration only. Other embodiments could be used without departing from the scope of the present disclosure. Information bits 110 can be first encoded by an encoder 120 such as a low density parity check (LDPC) encoder or polar encoder, and then modulated by a modulator 130. The modulation can be, for example, binary phase-shift keying (BPSK), quadrature amplitude modulation (QAM) 4, QAM 16, QAM 64, or QAM 256. Then a serial to parallel (S/P) converter 140 can generate parallel multiple modulation symbols that are subsequently inputted to a RE mapper and precoder 150. The RE mapper and precoder 150 can map the modulation symbols to selected REs and then apply some precoder on the modulation symbols on the BW resource assigned to a DL or UL transmission. Then in 160, the modulation symbols are applied with an inverse fast fourier transform (IFFT) and an output thereof is then serialized by a parallel to serial (P/S) converter 170. Then the signals are sent to a Tx unit 180 including for example a digital-to-analog (D/A) convertor, a radio frequency convertor, a filter, a power amplified, and Tx antenna elements, and transmitted out.

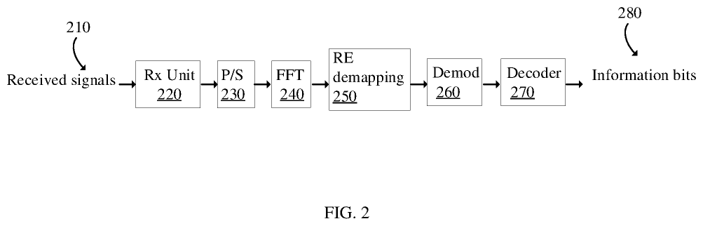

FIG. 2 illustrates a receiver block diagram for receiving a DL or UL transmission. An embodiment of the receiver block illustrated in FIG. 2 is for illustration only. Other embodiments could be used without departing from the scope of the present disclosure. Received signals 210 are first passed through a Rx unit 220 including for example Rx antenna elements, a low noise power amplifier, radio frequency converters, and filters. And an output thereof is passed through a P/S 230 and then applied an FFT 240. After converting into a frequency domain, useful signals are extracted by a RE demapping 250 according to a resource allocation for the DL or UL transmission. Subsequently, a demod 260 demodulates data symbols with a channel estimation that is calculated based on DM-RS and then a decoder 270 such as LDPC decoder or polar decoder, decodes the demodulated data to output information bits 280.

In 3rd generation partnership project (3GPP) release 15, a beam failure recovery function for a primary cell (PCell) is specified, which can be called as a link recovery. To perform a beam failure recovery for the primary cell, a user equipment can be configured with a set of reference signals (RSs) as a beam failure detection (BFD) RS and another set of RSs as a new beam identification (NBI) RS. The UE can first monitor the RS configured as the BFD RS and use a hypocritical block error rate (BLER) as metric to detect a beam failure of a physical downlink control channel (PDCCH) in one active bandwidth part (BWP) in the primary cell. If the UE detects the beam failure and the UE also finds at least one NBI RS that has a reference signal received power (RSRP) larger than a configured threshold, the UE then transmits a random access channel (RACH) preamble in a given RACH resource occasion which are configured to be associated with one NBI RS that is selected by the UE. A transmission of the RACH preamble in a given RACH resource can be considered as a beam failure recovery request (BFRR) to a gNB. If the gNB detects such a relay-assisted cellular network (RACN) preamble successfully, the gNB would use a quasi-co-location (QCL) assumption of the NBI RS indicated by the detected RACH preamble to transmit PDCCH in a search space that is dedicated for beam failure recovery response. After sending the RACH preamble as the BFRR, the UE can begin to monitor the PDCCH in the dedicated search space and if a valid PDCCH is detected, the UE can assume the gNB to receive the BFRR successfully.

In 5G NR release 15, multi-beam-based systems are supported. Multiplex Tx and Rx analog beams are employed by a base station (BS) and/or a user equipment (UE) to combat the large path loss in high frequency band. In a high frequency band system, for example, mmWave systems, the BS and the UE are deployed with large number of antennas so that large gain beamforming can be used to defeat the large path loss and signal blockage. Due to the hardware limitation and cost, the BS and the UE might only be equipped with limited number of TXRUs (transmission and reception units). Therefore, hybrid beamforming mechanisms can be utilized in both the BS and the UE. To get the best link quality between the BS and the UE, the BS and the UE need to align the analog beam directions for particular downlink or uplink transmission. For downlink transmission, they need find the best pair of BS Tx beam and UE Rx beam while for uplink transmission, they need to find the best pair of UE Tx beam and BS Rx beam. In 3GPP 5G specification, the following functions are defined to support such multi-beam-based operation: beam measurement and reporting, beam indication and beam switch.

New radio (NR)/fifth generation (5G) system supports transmission of channel state information reference signal (CSI-RS). The CSI-RS transmission can be used for time/frequency tracking, CSI computation, layer 1 reference signal received power (L1-RSRP) computation, layer 1 signal to interference plus noise ratio (L1-SINR) computation, and mobility measurement. Three types of CSI-RS resources are supported: periodic, semi-persistent, and aperiodic.

The CSI-RS resources are configured to a user equipment (UE) through a radio resource control (RRC) signaling. The UE can be configured with multiple CSI-RS resource sets through an RRC parameter non-zero power (NZP)-CSI-RS-Resource set, which is asset of NZP CSI-RS resources and set-specific parameters. A CSI-RS resource set configured with higher layer parameter trs-info contains the CSI-RS resources used for time/frequency tracking. A UE can be configured with a set of periodic CSI-RS resources. The UE can also be configured with a set of periodic CSI-RS resources and a second set of aperiodic CSI-RS resources. The aperiodic CSI-RS resources for tracking are QCLed with respect to QCL-TypeA and QCL-TypeD with the periodic CSI-RS for tracking. The CSI-RS resource for time/frequency tracking is also called TRS (tracking reference signal). The CSI-RS resource set configured for L1-RSRP computation or L1-SINR computation is configured with higher layer parameter repetition. The value of higher layer parameter repetition can be on or off.

To assist the UE to receive a CSI-RS resource transmission, the CSI-RS resource can be configured or indicated with a QCL configuration, which contains the information of QCL source RS(s) and QCL type(s). The supported types of QCL are: QCL-TypeA for doppler shift, doppler spread, average delay and delay spread, QCL-TypeB for doppler shift and doppler spread, QCL-TypeC for doppler shift, and average delay and QCL-TypeD for spatial Rx parameter.

Different methods are used to provide QCL configuration for different types of CSI-RS resources:

For a periodic CSI-RS resource: a quasi co-location (QCL) configuration is provided through a higher layer parameter qcl-InfoPeriodicCSI-RS to a periodic NZP CSI-RS resource. The higher layer parameter qcl-InfoPeriodicCSI-RS contains a reference to a TCI-state indicating QCL source RS(s) and QCL type(s). The configuration of the higher layer parameter qcl-InfoPeriodicCSI-RS to periodic NZP CSI-RS resource is optional.

For an aperiodic NZP CSI-RS resource: for each aperiodic CSI-RS resource in a CSI-RS resource set associated with each CSI triggering state, the UE is indicated a quasi co-location configuration (QCL) of quasi co-location RS source(s) and quasi co-location type(s), through higher layer signaling of qcl-info which contains a list of references to TCI-State's for the aperiodic CSI-RS resources associated with the CSI triggering state. As specified in NR specification, qcl-info is configured for aperiodic CSI-RS resource.

For a semi-persistent NZP CSI-RS resource, a QCL configuration is provided by a medium access control (MAC) control element (CE) message. When a UE receives an activation command, for CSI-RS resource set(s) for channel measurement and CSI interference measurement (CSI-IM)/NZP CSI-RS resource set(s) for interference measurement associated with configured CSI resource setting(s), and when a hybrid automatic repeat request acknowledgement (HARQ-ACK) corresponding to a physical downlink shared channel (PDSCH) carrying the selection command is transmitted in slot n, the corresponding actions and the UE assumptions (including QCL assumptions provided by a list of reference to TCI-State's, one per activated resource) on CSI-RS/CSI-IM transmission corresponding to the configured CSI-RS/CSI-IM resource configuration(s) are applied starting from the first slot that is after slot n+3ₛₗₒₜ^{subframe,μ}. If a TCI-State referred g slot to in the list is configured with a reference to an RS associated with QCL-TypeD, that RS can be an a synchronization signal (SS) and physical broadcast channel (PBCH) (SS/PBCH) block, periodic or semi-persistent CSI-RS located in same or different component carrier (CC)/downlink (DL) bandwidth part (BWP).

The QCL configuration types that can be configured to a CSI-RS resource depends on the usage of CSI-RS resource: for time/frequency tracking, for L1-RSRP measurement, for L1-SINR measurement, and for CSI computation.

For periodic TRS: the QCL configuration can be: QCL-TypeC and QCL-TypeD with an SS/PBCH Block or QCL-TypeC with an SS/PBCH Block and QCL-TypeD with a CSI-RS resource for beam management.

For aperiodic TRS: QCL-TypeA with a periodic TRS and QCL-TypeD with the same TRS.

For CSI-RS resource for CSI computation: QCL-TypeA and QCL-TypeD with a same TRS; QCL-TypeA with a TRS and QCL-TypeD with an SS/PBCH block; QCL-TypeA with a TRS and QCL-TypeD with an CSI-RS for beam management; or QCL-TypeB with a TRS.

For a CSI-RS resource beam management: QCL-TypeA and QCL-TypeD with a same TRS; QCL-TypeA with a TRS and QCL-TypeD with a CSI-RS resource for beam management; or QCL-TypeC and QCL-TypeD with the same SS/PBCH block.

For PDCCH or PDSCH, the UE can be configured with the following QCL configurations. QCL-TypeA and QCL-TypeD with a same TRS; QCL-TypeA with a TRS and QCL-TypeD with a CSI-RS resource for beam management; or QCL-TypeA and QCL-TypeD with a same CSI-RS resource not configured for TRS or beam management.

In a current specification, the configuration of qcl-InfoPeriodicCSI-RS to a periodic NZP CSI-RS resource is not mandatory but is optional. For a periodic NZP CSI-RS resource without qcl-InfoPeriodicCSI-RS, the network such as the base station can apply any different Tx beams and can even change the Tx beam on the transmission in the same NZP CSI-RS resource from time to time. Thus, the UE behavior of receiving that NZP CSI-RS resource is ambiguous. The UE does not know whether it can use the same Rx beam to receive multiple transmission instances of the same NZP CSI-RS resource. The UE does not know whether it can average the measurement of multiple transmission instances of the same NZP CSI-RS resource.

Some embodiments of the present disclosure provide an apparatus and a method of determining a quasi-co-location (QCL) configuration, which can solve issues in the prior art, provide a clear UE behavior of processing a periodic resource, provide a good communication performance, and/or provide high reliability.

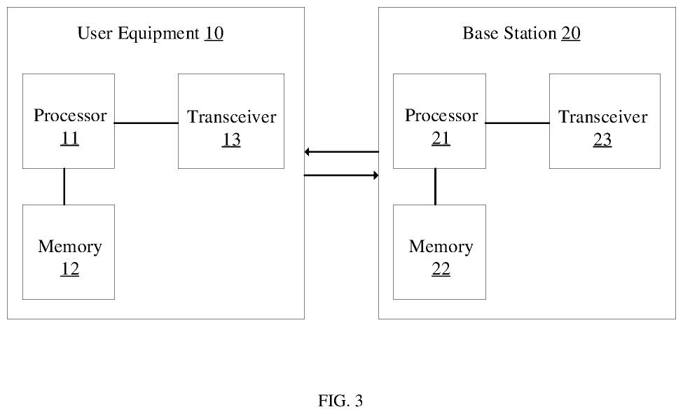

FIG. 3 illustrates that, in some embodiments, a user equipment (UE) 10 and a base station 20 of determining a quasi-co-location (QCL) configuration according to an embodiment of the present disclosure are provided. The UE 10 may include a processor 11, a memory 12, and a transceiver 13. The base station 20 such as a gNB may include a processor 21, a memory 22 and a transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21, and the transceiver 13 or 23 transmits and/or receives a radio signal.

The processor 11 or 21 may include an application-specific integrated circuit (ASIC), other chipsets, logic circuit and/or data processing devices. The memory 12 or 22 may include a read-only memory (ROM), a random access memory (RAM), a flash memory, a memory card, a storage medium and/or other storage devices. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21, in which those can be communicatively coupled to the processor 11 or 21 via various means are known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) release 14, 15, 16, and beyond. UEs communicate with each other directly via a sidelink interface such as a PC5 interface.

In some embodiments, for a periodic resource, if a quasi-co-location (QCL) configuration is not provided to the processor 11 by the base station 20, the processor 11 derives a QCL assumption for the periodic resource. This can solve issues in the prior art, provide a clear UE behavior of processing a periodic resource, provide a good communication performance, and/or provide high reliability.

In some embodiments, for a periodic resource, if a quasi-co-location (QCL) configuration is not provided to the user equipment (UE) 10 by the transceiver 23, the processor 21 controls the UE 10 to derive a QCL assumption for the periodic resource. This can solve issues in the prior art, provide a clear UE behavior of processing a periodic resource, provide a good communication performance, and/or provide high reliability.

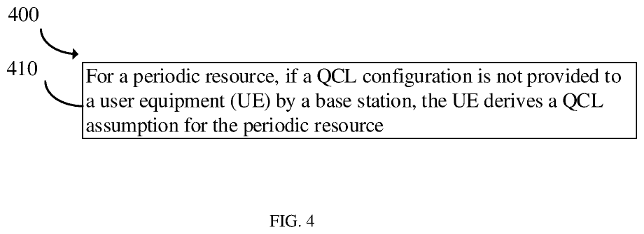

FIG. 4 illustrates a method 400 of determining a quasi-co-location (QCL) configuration by a UE according to an embodiment of the present disclosure. The method 400 includes: a block 410, for a periodic resource, if a QCL configuration is not provided to a user equipment (UE) by a base station, the UE derives a QCL assumption for the periodic resource. This can solve issues in the prior art, provide a clear UE behavior of processing a periodic resource, provide a good communication performance, and/or provide high reliability.

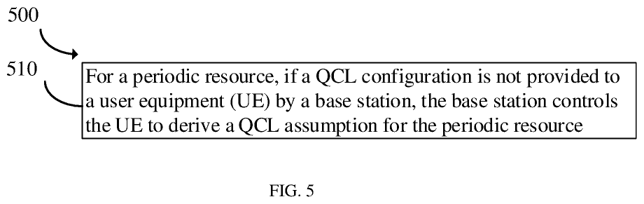

FIG. 5 illustrates a method 500 of determining a quasi-co-location (QCL) configuration by a base station according to an embodiment of the present disclosure. The method 500 includes: a block 510, for a periodic resource, if a QCL configuration is not provided to a user equipment (UE) by a base station, the base station controls the UE to derive a QCL assumption for the periodic resource. This can solve issues in the prior art, provide a clear UE behavior of processing a periodic resource, provide a good communication performance, and/or provide high reliability.

In some embodiments, the periodic resource comprises a periodic tracking reference signal (TRS) resource or a periodic channel state information reference signal (CSI-RS) resource. In some embodiments, for the periodic TRS resource, if the QCL configuration is not provided, the UE derives the QCL assumption for the periodic TRS resource. In some embodiments, for the periodic TRS resource, if the QCL configuration is not provided, the UE derives the QCL assumption for the periodic TRS resource according to at least one of the followings: the UE assumes that the QCL assumption for the periodic TRS resource is provided by a synchronization signal (SS) and physical broadcast channel (PBCH) (SS/PBCH) block used to obtain a master information block (MIB); the UE assumes that the QCL assumption for the periodic TRS resource has QCL-TypeC with the SS/PBCH block used to obtain the MIB and QCL-TypeD with the same SS/PBCH block when applicable; the UE assumes that the QCL assumption for the periodic TRS resource is used to receive a message 2 (msg2) in a most recent successful physical random access channel (PRACH) transmission; the UE assumes that the QCL assumption for the periodic TRS resource has the QCL-TypeD with a receive (Rx) spatial parameter used to receive a message 3 (msg3) in the most recent successful PRACH transmission; the UE assumes that the QCL assumption for the periodic TRS resource is provided by a transmission configuration indicator state (TCI-state) or the QCL assumption configured to a control resource set (CORESET) #0; the UE assumes that the QCL assumption for the periodic TRS resource is provided by the TCI-state with a lowest TCI-state ID configured in a serving cell for the UE; the UE assumes that the QCL assumption for the periodic TRS resource is provided by the TCI-state configured to a CORESET with a lowest CORESET ID in the serving cell; the UE assumes that the QCL assumption for the periodic TRS resource is provided by the TCI-state configured to the CORESET with the lowest CORESET ID in an active bandwidth part (BWP) of the serving cell; the UE assumes that the QCL assumption for the periodic TRS resource is provided by the TCI-state configured to the CORESET with the lowest CORESET ID in a latest slot in which one or more CORESETs within the active BWP are monitored by the UE in the serving cell; the UE assumes that the QCL assumption for the periodic TRS resource is provided by an activated TCI-state with a lowest ID among TCI-states activated for a physical downlink shared channel (PDSCH) transmission in the active BWP of the serving cell; or the UE assumes that the QCL assumption for the periodic TRS resource is provided by the activated TCI-state corresponding to a lowest TCI codepoint among the TCI-states activated for the PDSCH transmission in the active BWP of the serving cell.

In some embodiments, the QCL assumption for the periodic TRS resource is provided by a reference signal configured in the TCI-state configured to the CORESET with the lowest CORESET ID in the active BWP of the serving cell. In some embodiments, the QCL assumption for the periodic TRS resource is provided by a reference signal configured in the TCI-state configured to the CORESET with the lowest CORESET ID in the serving cell. In some embodiments, the QCL assumption for the periodic TRS resource is provided by a reference signal configured in the TCI-state configured to the CORESET with the lowest CORESET ID in the latest slot in which one or more CORESETs within the active BWP are monitored by the UE in the serving cell. In some embodiments, the QCL assumption for the periodic TRS resource is provided by a reference signal configured in the activated TCI-state with the lowest ID applicable to a PDSCH in an active downlink BWP of the serving cell if the UE is not configured with any CORESET in the serving cell.

In some embodiments, for the periodic TRS resource, if a QCL type D (QCL-TypeD) is applicable but the QCL configuration is not provided, the UE derives a QCL-typeD assumption for the periodic TRS resource. In some embodiments, for the periodic TRS resource, if the QCL-TypeD is applicable but the QCL configuration is not provided, the UE derives the QCL-typeD assumption for the periodic TRS resource according to at least one of the followings: the UE assumes the QCL-typeD assumption for the periodic TRS resource has the QCL-TypeD with a SS/PBCH block used to obtain a MIB; the UE assumes that the QCL-typeD assumption for the periodic TRS resource has the QCL-TypeD with a receive (Rx) spatial parameter used to receive a message (msg3) in a most recent successful PRACH transmission; the UE assumes that the QCL-typeD assumption for the periodic TRS resource resource is a CSI-RS resource in an CSI-RS-resource set configured with a higher layer parameter; the UE assumes that the QCL-typeD assumption for the periodic TRS resource is provided by a reference signal associated with the QCL-TypeD configured in a TCI-state configured to a CORESET #0 or by the reference signal associated with the QCL assumption indicated to the CORESET #0; the UE assumes that the QCL-typeD assumption for the periodic TRS resource is provided by the reference signal associated with the QCL-TypeD configured in the TCI-state configured to the CORESET with a lowest CORESET ID in the serving cell; the UE assumes that the QCL-typeD assumption for the periodic TRS resource is provided by the reference signal associated with the QCL-TypeD configured in the TCI-state configured to the CORESET with the lowest CORESET ID in an active BWP of the serving cell; the UE assumes that the QCL-typeD assumption for the periodic TRS resource is provided by the reference signal associated with the QCL-TypeD configured in the TCI-state configured to the CORESET with the lowest CORESET ID in a latest slot in which one or more CORESETs within the active BWP are monitored by the UE in the serving cell; the UE assumes that the QCL-typeD assumption for the periodic TRS resource is provided by the reference signal associated with the QCL-TypeD configured in an activated TCI-state with a lowest ID among TCI states activated for a PDSCH in the active BWP of the serving cell; or the UE assumes that the QCL-typeD assumption for the periodic TRS resource is provided by the reference signal associated with the QCL-TypeD configured in the TCI-state with the lowest ID configured in the serving cell. In some embodiments, the CSI-RS resource is one with a lowest CSI-RS resource ID in the CSI-RS-resource set configured with the higher layer parameter.

In some embodiments, for the periodic CSI-RS resource for a CSI computation, if the QCL configuration is not provided, the UE derives the QCL assumption for the periodic CSI-RS resource. In some embodiments, for the periodic CSI-RS resource for the CSI computation, if the QCL configuration is not provided, the UE derives the QCL assumption for the periodic CSI-RS resource according to at least one of the followings: the UE assumes that the QCL assumption for the periodic CSI-RS resource is provided by a SS/PBCH block used to obtain a MIB; the UE assumes that the QCL assumption for the periodic CSI-RS resource has a QCL-TypeC with the SS/PBCH block used to obtain the MIB and a QCL-TypeD with the same SS/PBCH block when applicable; the UE assumes that the QCL assumption for the periodic CSI-RS resource is used to receive a msg2 in a most recent successful PRACH transmission; the UE assumes that the QCL assumption for the periodic CSI-RS resource has the QCL-TypeD with a Rx spatial parameter used to receive a msg3 in the most recent successful PRACH transmission; the UE assumes that the QCL assumption for the periodic CSI-RS resource is provided by a TCI-state or the QCL assumption configured to a CORESET #0; the UE assumes that the QCL assumption for the periodic CSI-RS resource is provided by the TCI-state with a lowest TCI-state ID configured in the serving cell; the UE assumes that the QCL assumption for the periodic CSI-RS resource is provided by the TCI-state configured to a CORESET with a lowest CORESET ID in the serving cell; the UE assumes that the QCL assumption for the periodic CSI-RS resource is provided by the TCI-state configured to the CORESET with the lowest CORESET ID in an active BWP of the serving cell; the UE assumes that the QCL assumption for the periodic CSI-RS resource is provided by the TCI-state configured to the CORESET with the lowest CORESET ID in a latest slot in which one or more CORESETs within the active BWP are monitored by the UE in the serving cell; the UE assumes that the QCL assumption for the periodic CSI-RS resource is provided by an activated TCI-state with a lowest ID among TCI-states activated for a PDSCH transmission in the active BWP of the serving cell; the UE assumes that the QCL assumption for the periodic CSI-RS resource is provided by the activated TCI-state corresponding to a lowest TCI codepoint among the TCI-states activated for the PDSCH transmission in the active BWP of the serving cell; or the UE assumes that the QCL assumption for the periodic CSI-RS resource is provided by the CSI-RS resource with a lowest CSI-RS-Resource ID among all the CSI-RS resources configured in a CSI-RS-Resource set without a higher layer parameter.

In some embodiments, the QCL assumption for the periodic CSI-RS resource is provided by the reference signal configured in the TCI-state configured to the CORESET with the lowest CORESET ID in the active BWP of the serving cell. In some embodiments, the QCL assumption for the periodic CSI-RS resource is provided by the reference signal configured in the TCI-state configured to the CORESET with the lowest CORESET ID in the serving cell. In some embodiments, the QCL assumption for the periodic CSI-RS resource is provided by the reference signal configured in the TCI-state configured to the CORESET with the lowest CORESET ID in the latest slot in which one or more CORESETs within the active BWP are monitored by the UE in the serving cell. In some embodiments, the QCL assumption for the periodic CSI-RS resource is provided by the reference signal configured in the activated TCI-state with the lowest ID applicable to a PDSCH in an active downlink BWP of the serving cell if the UE is not configured with any CORESET in the serving cell.

In some embodiments, for the periodic CSI-RS resource for beam management, if the QCL configuration is not provided, the UE derives a QCL-typeA assumption for the periodic CSI-RS resource. In some embodiments, for the periodic CSI-RS resource for beam management, if the QCL configuration is not provided, the UE derives the QCL-typeA assumption for the periodic CSI-RS resource according to at least one of the followings: the UE assumes that the QCL-typeA assumption for the periodic CSI-RS resource is provided by a SS/PBCH block used to obtain a MIB; the UE assumes that the QCL-typeA assumption for the periodic CSI-RS resource is provided by a reference signal for QCL-TypeA configured in a TCI-state configured to a CORESET #0 or the QCL assumption indicated for a CORESET #0; the UE assumes that the QCL-typeA assumption for the periodic CSI-RS resource is provided by the reference signal related with reception of a msg2 in a most recent successful PRACH transmission; the UE assumes that the QCL-typeA assumption for the periodic CSI-RS resource is provided by a CSI-RS resource with a lowest ID among all the CSI-RS resources configured in a CSI-RS-resource set configured with a higher layer parameter; the UE assumes that the QCL-typeA assumption for the periodic CSI-RS resource is provided by the reference signal associated with QCL-TypeA configured in the TCI-state with a lowest ID configured in the serving cell; the UE assumes that the QCL-typeA assumption for the periodic CSI-RS resource is provided by the reference signal associated with QCL-TypeA configured in the TCI-state configured to the CORESET with a lowest ID configured in the serving cell; the UE assumes that the QCL-typeA assumption for the periodic CSI-RS resource is provided by the reference signal associated with QCL-TypeA configured in the TCI-state configured to the CORESET with the lowest ID configured in an active BWP of serving cell; the UE assumes that the QCL-typeA assumption for the periodic CSI-RS resource is provided by the reference signal associated with QCL-TypeA configured in the TCI-state configured to the CORESET with the lowest CORESET ID in a latest slot in which one or more CORESETs within the active BWP are monitored by the UE in the serving cell; or the UE assumes that the QCL-typeA assumption for the periodic CSI-RS resource is provided by the reference signal associated with QCL-TypeA configured in the TCI-state with the lowest ID applicable to a PDSCH in the active BWP of the serving cell. In some embodiments, the periodic CSI-RS resource is used for CSI computation or for beam management.

Some embodiments of the present disclosure provide an apparatus and a method of determining a quasi-co-location (QCL) configuration, which can solve issues in the prior art, provide a clear UE behavior of processing a periodic resource, provide a good communication performance, and/or provide high reliability.

In one method, the UE expects that a periodic NZP CSI-RS resource is always provided with qcl-InfoPeriodicCSI-RS.

In one embodiment, if QCL configuration is not provided to a first NZP CSI-RS resource, the UE can assume one or more of the following QCL configuration assumption is applied to the first NZP CSI-RS resource according to at least one of the followings.

A particular SS/PBCH block, for example the SS/PBCH block used to receive MIB, and the SS/PBCH block used to transmit msg2 in the most recent PRACH transmission.

The QCL configuration configured/indicated to the CORESET #0.

One particular, for example predefined, CSI-RS resource for time/frequency tracking. For example, a periodic CSI-RS resource with lowest nzp-CSI-RS-ResourceId among all the CSI-RS resources configured for time/frequency tracking.

One particular, for example predefined, CSI-RS resource for beam management. For example, a periodic CSI-RS resource with lowest nzp-CSI-RS-ResourceId among all the CSI-RS resources configured in NZP CSI-RS resource set configured with higher layer parameter repetition.

The QCL configuration indicated a TCI-state configured to one CORESET, for example the CORESET with lowest ID in the same CC, the CORESET with lowest ID in the same DL BWP of the same CC.

The QCL configuration indicted by the TCI-state with lowest TCI-state ID configured in the same CC.

The QCL configuration indicated by the TCI-state with lowest TCI-state ID configured in one particular CC.

The QCL configuration indicated by the TCI-state indicated for PDSCH transmission in the same CC.

The QCL configuration indicated by the TCI-state indicated for PDSCH transmission in the same BWP and in same CC.

The QCL configuration indicated by the activated TCI-state with the lowest ID applicable to PDSCH in the active BWP. For example, one MAC CE command can activate up to 8 TCI-states for PDSCH transmission in one BWP, the TCI-state with lowest ID among those activated TCI-state can provide the QCL configuration for NZP CSI-RS resource without with qcl-InfoPeriodicCSI-RS.

The QCL configuration provided by the TCI-state configured to the CORESET with lowest controlResourceSetId in the latest slot in which one or more CORESETs within the active BWP are monitored by the UE in the serving cell.

In one method, for a periodic CSI-RS resource in an NZP-CSI-RS-ResourceSet configured with higher layer parameter trs-Info, i.e., a CSI-RS resource used for time/frequency tracking, if the higher layer parameter qcl-InfoPeriodicCSI-RS is not provided, the UE can derive a default QCL assumption for the target CSI-RS resource according one or more of the followings.

The UE can assume the SS/PBCH used to obtain the MIB provides the QCL configuration to the periodic CSI-RS resource.

The UE can assume the QCL configuration for the periodic CSI-RS resource has ‘QCL-TypeC’ with the SS/PBCH block used to obtain MIB and, when applicable ‘QCL-TypeD’ with the same SS/PBCH block.

The UE can assume the QCL configuration is the QCL assumption used to receive the msg2 in the most recent successful PRACH transmission.

The UE can assume the QCL configuration for the periodic CSI-RS resource has QCL-TypeD with the Rx spatial parameter used to receive msg3 in the most recent successful PRACH transmission.

The UE can assume QCL configuration for the periodic CSI-RS resource is provided by the TCI-state or QCL assumption configured to the CORESET #0.

The UE can assume the QCL assumption for the periodic CSI-RS resource is provided by the TCI-state with lowest TCI-stateId configured in the serving cell.

The UE can assume the QCL assumption for the periodic CSI-RS resource is provided by the TCI-state configured to the CORESET with lowest controlResourceSetId in the serving cell.

The UE can assume the QCL assumption for the periodic CSI-RS resource is provided by the TCI-state configured to the CORESET with lowest controlResourceSetId in the active BWP of the serving cell.

The UE can assume the QCL assumption for the periodic CSI-RS resource is provided by the TCI-state configured to the CORESET with lowest controlResourceSetId in the latest slot in which one or more CORESETs within the active BWP are monitored by the UE in the serving cell.

The UE can assume the QCL assumption for the periodic CSI-RS resource is provided by the activated TCI-state with lowest ID among the TCI-states activated for PDSCH transmission in the active BWP of the serving cell.

The UE can assume the QCL assumption for the periodic CSI-RS resource is provided by the activated TCI-state corresponding to the lowest TCI codepoint among the TCI-states activated for PDSCH transmission in the active BWP of the serving cell.

The above methods can be applied to a periodic CSI-RS resource configured in in an NZP-CSI-RS-ResourceSet with the higher layer parameter repetition if the higher layer parameter qcl-InfoPeriodicCSI-RS is not provided to the target CSI-RS resource.

In one example, if a periodic CSI-RS configured in an NZP-CSI-RS-ResourceSet configured with higher layer parameter trs-Info is not provided with the higher layer parameter qcl-InfoPeriodicCSI-RS, the UE derives the QCL assumption for the target CSI-RS resource as follows.

The QCL configuration is provided by the reference signal(s) configured in the TCI-state configured to the CORESET with lowest controlResourceSetId in the active BWP of the serving cell.

Another alternative method: The QCL configuration is provided by the reference signal(s) configured in the TCI-state configured to the CORESET with lowest controlResourceSetId in the serving cell.

Another alternative method: The QCL configuration is provided by the reference signal(s) configured in the TCI-state configured to the CORESET with lowest controlResourceSetId in the latest slot in which one or more CORESETs within the active BWP are monitored by the UE in the serving cell.

The QCL configuration is provided by the reference signal(s) configured in the activated TCI state with the lowest ID applicable to PDSCH in the active DL BWP of the serving cell if the UE is not configured with any CORESET in the serving cell.

In one method, if QCL-TypeD is not provided to a periodic TRS resource, the UE can assume a default QCL-typeD assumption for the TRS resource. In one example, for a periodic CSI-RS resource in an NZP-CSI-RS-ResourceSet configured with higher layer parameter trs-Info, if QCL-TypeD is applicable, but if the higher layer parameter qcl-InfoPeriodicCSI-RS is not provided, the UE can derive the default QCL-typeD assumption for the target CSI-RS resource according to at least one or more of the followings.

The UE can assume the QCL configuration for the periodic CSI-RS resource has ‘QCL-TypeD’ with the SS/PBCH block used to obtain MIB.

The UE can assume the QCL configuration for the periodic CSI-RS resource has QCL-TypeD with the Rx spatial parameter used to receive msg3 in the most recent successful PRACH transmission.

The UE can assume the QCL-typeD assumption for the periodic CSI-RS resource is a particular NZP CSI-RS resource in an NZP-CSI-RS-ResourceSet configured with higher layer parameter repetition. In one example, the particular NZP CSI-RS resource is the one with lowest NZP CSI-RS resource ID in an NZP-CSI-RS-ResourceSet configured with higher layer parameter repetition.

The UE can assume the QCL-typeD assumption for the periodic CSI-RS resource is provided by the reference signal associated with QCL-TypeD configured in the TCI-state configured to CORESET #0 or by the reference signal associated with QCL assumption indicated to the CORESET #0.

The UE can assume the QCL-typeD assumption for the periodic CSI-RS resource is provided by the reference signal associated with QCL-TypeD configured in the TCI-state configured to the CORESET with lowest controlResourceSetId in the serving cell.

The UE can assume the QCL-typeD assumption for the periodic CSI-RS resource is provided by the reference signal associated with QCL-TypeD configured in the TCI-state configured to the CORESET with lowest controlResourceSetId in the active BWP of serving cell.

The UE can assume the QCL-typeD assumption for the periodic CSI-RS resource is provided by the reference signal associated with QCL-TypeD configured in the TCI-state configured to the CORESET with lowest controlResourceSetId in the latest slot in which one or more CORESETs within the active BWP are monitored by the UE in the serving cell.

The UE can assume the QCL-typeD assumption for the periodic CSI-RS resource is provided by the reference signal associated with QCL-TypeD configured in the activated TCI-state with lowest ID among the TCI states activated for the PDSCH in the active BWP of the serving cell.

The UE can assume the QCL-typeD assumption for the periodic CSI-RS resource is provided by the reference signal associated with QCL-TypeD configured in the TCI-state with lowest ID configured in the serving cell.

The above methods can be applied to a periodic CSI-RS resource configured in in an NZP-CSI-RS-ResourceSet with the higher layer parameter repetition if the higher layer parameter qcl-InfoPeriodicCSI-RS is not provided to the target CSI-RS resource.

In one method, for a periodic CSI-RS resource in an NZP-CSI-RS-ResourceSet without higher layer parameter trs-Info and without the higher layer parameter repetition, i.e., a CSI-RS resource not used for time/frequency tracking and not used for beam management, if the higher layer parameter qcl-InfoPeriodicCSI-RS is not provided, the UE can derive QCL assumption for the target CSI-RS resource according one or more of the followings.

The UE can assume the SS/PBCH used to obtain the MIB provides the QCL configuration to the periodic CSI-RS resource.

The UE can assume the QCL configuration for the periodic CSI-RS resource has ‘QCL-TypeC’ with the SS/PBCH block used to obtain MIB and, when applicable ‘QCL-TypeD’ with the same SS/PBCH block.

The UE can assume the QCL configuration is the QCL assumption used to receive the msg2 in the most recent successful PRACH transmission.

The UE can assume the QCL configuration for the periodic CSI-RS resource has QCL-TypeD with the Rx spatial parameter used to receive msg3 in the most recent successful PRACH transmission.

The UE can assume QCL configuration for the periodic CSI-RS resource is provided by the TCI-state or QCL assumption configured to the CORESET #0.

The UE can assume the QCL assumption for the periodic CSI-RS resource is provided by the TCI-state with lowest TCI-stateId configured in the serving cell.

The UE can assume the QCL assumption for the periodic CSI-RS resource is provided by the TCI-state configured to the CORESET with lowest controlResourceSetId in the serving cell.

The UE can assume the QCL assumption for the periodic CSI-RS resource is provided by the TCI-state configured to the CORESET with lowest controlResourceSetId in the active BWP of the serving cell.

The UE can assume the QCL assumption for the periodic CSI-RS resource is provided by the TCI-state configured to the CORESET with lowest controlResourceSetId in the latest slot in which one or more CORESETs within the active BWP are monitored by the UE in the serving cell.

The UE can assume the QCL assumption for the periodic CSI-RS resource is provided by the activated TCI-state with lowest ID among the TCI-states activated for PDSCH transmission in the active BWP of the serving cell.

The UE can assume the QCL assumption for the periodic CSI-RS resource is provided by the activated TCI-state corresponding to the lowest TCI codepoint among the TCI-states activated for PDSCH transmission in the active BWP of the serving cell.

The UE can assume the QCL assumption for the periodic CSI-RS resource is provided by the CSI-RS resource with lowest nzp-CSI-RS-ResourceId among all the CSI-RS resources configured in NZP-CSI-RS-ResourceSet without higher layer parameter trs-Info. The method can make sure the UE use one TRS as the QCL assumption for a CSI-RS resource for CSI computation.

In one example, if a periodic CSI-RS configured in an NZP-CSI-RS-ResourceSet configured without higher layer parameter trs-Info and without higher layer parameter repetition is not provided with the higher layer parameter qcl-InfoPeriodicCSI-RS, the UE derives the QCL assumption for the target CSI-RS resource as follows.

The QCL configuration is provided by the reference signal(s) configured in the TCI-state configured to the CORESET with lowest controlResourceSetId in the active BWP of the serving cell.

Another alternative method: The QCL configuration is provided by the reference signal(s) configured in the TCI-state configured to the CORESET with lowest controlResourceSetId in the serving cell.

Another alternative method: The QCL configuration is provided by the reference signal(s) configured in the TCI-state configured to the CORESET with lowest controlResourceSetId in the latest slot in which one or more CORESETs within the active BWP are monitored by the UE in the serving cell.

The QCL configuration is provided by the reference signal(s) configured in the activated TCI state with the lowest ID applicable to PDSCH in the active DL BWP of the serving cell if the UE is not configured with any CORESET in the serving cell.

The CSI-RS resource configured in NZP-CSI-RS-ResourceSet with higher layer parameter repetition, can be used for beam training. If QCL-TypeD configuration is not provided to that CSI-RS resource, the UE can try different Rx beam to find the best beam pair link. However, the UE would need QCL-TypeA configuration to assist the reception of that CSI-RS resource. The UE can derive a default QCL-TypeA for the target CSI-RS resource according to at least one or more of the followings.

The UE can assume the QCL-typeA for the CSI-RS resource is provided by the SS/PBCH block used to obtain MIB.

The UE can assume the QCL-typeA for the CSI-RS resource is provided by the reference signal for QCL-TypeA configured in the TCI-state configured to the CORESET #0 or QCL assumption indicated for the CORESET #0.

The UE can assume the QCL-TypeA for the CSI-RS resource is provided by the reference signal related with the reception of the msg2 in the most recent successful PRACH transmission.

The UE can assume the QCL-TypeA for the CSI-RS resource is provided by the CSI-RS resource with lowest ID among all the CSI-RS resource configured in an NZP-CSI-RS-Resource-set configured with higher layer parameter trs-Info.

The UE can assume the QCL-TypeA for the CSI-RS resource is provided by the reference signal associated with QCL-TypeA configured in the TCI-state with lowest ID configured in the serving cell.

The UE can assume the QCL-TypeA for the CSI-RS resource is provided by the reference signal associated with QCL-TypeA configured in the TCI-state configured to the CORESET with lowest ID configured in the serving cell.

The UE can assume the QCL-TypeA for the CSI-RS resource is provided by the reference signal associated with QCL-TypeA configured in the TCI-state configured to the CORESET with lowest ID configured in the active BWP of serving cell.

The UE can assume the QCL-TypeA for the CSI-RS resource is provided by the reference signal associated with QCL-TypeA configured in the TCI-state configured to the CORESET with lowest controlResourceSetId in the latest slot in which one or more CORESETs within the active BWP are monitored by the UE in the serving cell.

The UE can assume the QCL-TypeA for the CSI-RS resource is provided by the reference signal associated with QCL-TypeA configured in the TCI-state with the lowest ID applicable to PDSCH in the active BWP of the serving cell.

In some embodiments of this disclosure, the following methods are presented.

For a periodic TRS, if the QCL configuration is not provided, the UE derives a default QCL assumption for the periodic TRS according to various methods.

For a parodic TRS, if QCL-TypeD is applicable but QCL configuration is not provided, the UE derives a default QCL-typeD assumption for the periodic TRS according to various methods. TRS is the source for QCL-TypeA for all the other CSI-RS resource, PDCCH and PDSCH, thus it is not right to use any other signal (expect SSB) as the QCL-TypeC for TRS. But the QCL-TypeD for a TRS can be a CSI-RS resource for BM or SS/PBCH. So, when QCL configuration is not provided, the UE can assume a default QCL-TypeD for the TRS but not for QCL-TypeC.

For a periodic CSI-RS resource for CSI computation, if the QCL configuration is not provided, the UE derives a default QCL assumption for the periodic CSI-RS resource according to various methods.

For a periodic CSI-RS resource for beam management, if QCL configuration is not provided, the UE derives a default QCL-TypeA assumption for the target CSI-RS resource.

Commercial interests for some embodiments are as follows. 1. Solving issues in the prior art. 2. Providing a clear UE behavior of processing a periodic resource. 3. Providing a good communication performance. 4. Providing high reliability. 5. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, communication devices for public safety use, AR/VR device maker for example gaming, conference/seminar, education purposes. Some embodiments of the present disclosure are a combination of “techniques/processes” that can be adopted in 3GPP specification to create an end product. Some embodiments of the present disclosure could be adopted in the 5G NR licensed and non-licensed or shared spectrum communications. Some embodiments of the present disclosure propose technical mechanisms.

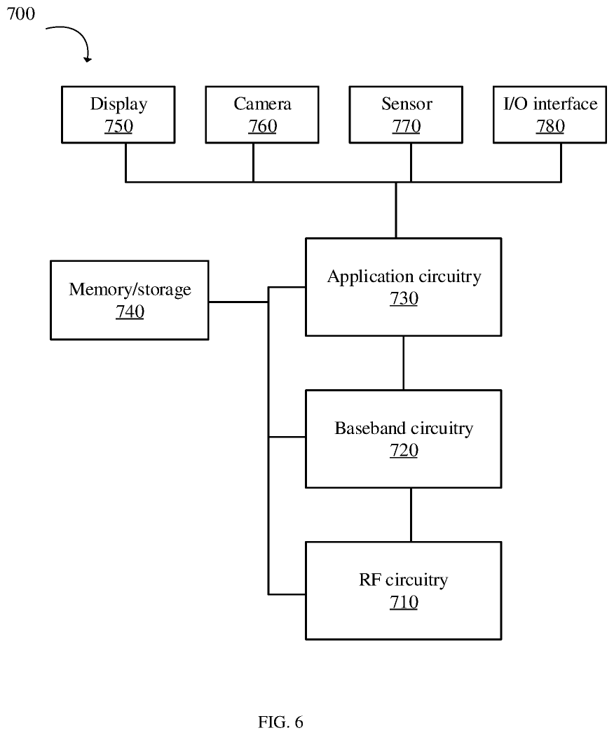

FIG. 6 is a block diagram of an example system 700 for wireless communication according to an embodiment of the present disclosure. Embodiments described herein may be implemented into the system using any suitably configured hardware and/or software. FIG. 6 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units. If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method of determining a quasi-co-location (QCL) configuration by a user equipment, comprising:
for a periodic resource, if a QCL configuration is not provided to a user equipment (UE) by a base station, the UE derives a QCL assumption for the periodic resource.

2. The method of claim 1, wherein the periodic resource comprises a periodic tracking reference signal (TRS) resource or a periodic channel state information reference signal (CSI-RS) resource.

3. The method of claim 2, wherein for the periodic TRS resource, if the QCL configuration is not provided, the UE derives the QCL assumption for the periodic TRS resource.

4. The method of claim 3, wherein for the periodic TRS resource, if the QCL configuration is not provided, the UE derives the QCL assumption for the periodic TRS resource according to at least one of the followings:
the UE assumes that the QCL assumption for the periodic TRS resource is provided by a synchronization signal (SS) and physical broadcast channel (PBCH) (SS/PBCH) block used to obtain a master information block (MIB);
the UE assumes that the QCL assumption for the periodic TRS resource has QCL-TypeC with the SS/PBCH block used to obtain the MIB and QCL-TypeD with the same SS/PBCH block when applicable;
the UE assumes that the QCL assumption for the periodic TRS resource is used to receive a message 2 (msg2) in a most recent successful physical random access channel (PRACH) transmission;
the UE assumes that the QCL assumption for the periodic TRS resource has the QCL-TypeD with a receive (Rx) spatial parameter used to receive a message 3 (msg3) in the most recent successful PRACH transmission;
the UE assumes that the QCL assumption for the periodic TRS resource is provided by a transmission configuration indicator state (TCI-state) or the QCL assumption configured to a control resource set (CORESET) #0;
the UE assumes that the QCL assumption for the periodic TRS resource is provided by the TCI-state with a lowest TCI-state ID configured in a serving cell for the UE;
the UE assumes that the QCL assumption for the periodic TRS resource is provided by the TCI-state configured to a CORESET with a lowest CORESET ID in the serving cell;
the UE assumes that the QCL assumption for the periodic TRS resource is provided by the TCI-state configured to the CORESET with the lowest CORESET ID in an active bandwidth part (BWP) of the serving cell;
the UE assumes that the QCL assumption for the periodic TRS resource is provided by the TCI-state configured to the CORESET with the lowest CORESET ID in a latest slot in which one or more CORESETs within the active BWP are monitored by the UE in the serving cell;
the UE assumes that the QCL assumption for the periodic TRS resource is provided by an activated TCI-state with a lowest ID among TCI-states activated for a physical downlink shared channel (PDSCH) transmission in the active BWP of the serving cell; or
the UE assumes that the QCL assumption for the periodic TRS resource is provided by the activated TCI-state corresponding to a lowest TCI codepoint among the TCI-states activated for the PDSCH transmission in the active BWP of the serving cell.

5. The method of claim 3, wherein the QCL assumption for the periodic TRS resource is provided by a reference signal configured in the TCI-state configured to the CORESET with the lowest CORESET ID in the active BWP of the serving cell.

6. The method of claim 3, wherein the QCL assumption for the periodic TRS resource is provided by a reference signal configured in the TCI-state configured to the CORESET with the lowest CORESET ID in the serving cell.

7. The method of claim 3, wherein the QCL assumption for the periodic TRS resource is provided by a reference signal configured in the TCI-state configured to the CORESET with the lowest CORESET ID in the latest slot in which one or more CORESETs within the active BWP are monitored by the UE in the serving cell.

8. A user equipment (UE), comprising:
a memory;
a transceiver; and
a processor coupled to the memory and the transceiver,
wherein for a periodic resource, if a quasi-co-location (QCL) configuration is not provided to the processor by a base station, the processor derives a QCL assumption for the periodic resource.

9. The UE of claim 8, wherein the periodic resource comprises a periodic tracking reference signal (TRS) resource or a periodic channel state information reference signal (CSI-RS) resource.

10. The UE of claim 9, wherein for the periodic TRS resource, if the QCL configuration is not provided, the processor derives the QCL assumption for the periodic TRS resource.

11. The UE of claim 10, wherein for the periodic TRS resource, if the QCL configuration is not provided, the processor derives the QCL assumption for the periodic TRS resource according to at least one of the followings:
the processor assumes that the QCL assumption for the periodic TRS resource is provided by a synchronization signal (SS) and physical broadcast channel (PBCH) (SS/PBCH) block used to obtain a master information block (MIB);
the processor assumes that the QCL assumption for the periodic TRS resource has QCL-TypeC with the SS/PBCH block used to obtain the MIB and QCL-TypeD with the same SS/PBCH block when applicable;
the processor assumes that the QCL assumption for the periodic TRS resource is used to receive a message 2 (msg2) in a most recent successful physical random access channel (PRACH) transmission;
the processor assumes that the QCL assumption for the periodic TRS resource has the QCL-TypeD with a receive (Rx) spatial parameter used to receive a message 3 (msg3) in the most recent successful PRACH transmission;
the processor assumes that the QCL assumption for the periodic TRS resource is provided by a transmission configuration indicator state (TCI-state) or the QCL assumption configured to a control resource set (CORESET) #0;
the processor assumes that the QCL assumption for the periodic TRS resource is provided by the TCI-state with a lowest TCI-state ID configured in a serving cell for the UE;
the processor assumes that the QCL assumption for the periodic TRS resource is provided by the TCI-state configured to a CORESET with a lowest CORESET ID in the serving cell;
the processor assumes that the QCL assumption for the periodic TRS resource is provided by the TCI-state configured to the CORESET with the lowest CORESET ID in an active bandwidth part (BWP) of the serving cell;
the processor assumes that the QCL assumption for the periodic TRS resource is provided by the TCI-state configured to the CORESET with the lowest CORESET ID in a latest slot in which one or more CORESETs within the active BWP are monitored by the processor in the serving cell;
the processor assumes that the QCL assumption for the periodic TRS resource is provided by an activated TCI-state with a lowest ID among TCI-states activated for a physical downlink shared channel (PDSCH) transmission in the active BWP of the serving cell; or
the processor assumes that the QCL assumption for the periodic TRS resource is provided by the activated TCI-state corresponding to a lowest TCI codepoint among the TCI-states activated for the PDSCH transmission in the active BWP of the serving cell.

12. The UE of claim 10, wherein the QCL assumption for the periodic TRS resource is provided by a reference signal configured in the TCI-state configured to the CORESET with the lowest CORESET ID in the active BWP of the serving cell.

13. The UE of claim 10, wherein the QCL assumption for the periodic TRS resource is provided by a reference signal configured in the TCI-state configured to the CORESET with the lowest CORESET ID in the serving cell.

14. The UE of claim 10, wherein the QCL assumption for the periodic TRS resource is provided by a reference signal configured in the TCI-state configured to the CORESET with the lowest CORESET ID in the latest slot in which one or more CORESETs within the active BWP are monitored by the processor in the serving cell.

15. A base station, comprising:
a memory;
a transceiver; and
a processor coupled to the memory and the transceiver,
wherein for a periodic resource, if a quasi-co-location (QCL) configuration is not provided to a user equipment (UE) by the transceiver, the processor controls the UE to derive a QCL assumption for the periodic resource.

16. The base station of claim 15, wherein the periodic resource comprises a periodic tracking reference signal (TRS) resource or a periodic channel state information reference signal (CSI-RS) resource.

17. The base station of claim 16, wherein for the periodic TRS resource, if the QCL configuration is not provided, the UE derives the QCL assumption for the periodic TRS resource.

18. The base station of claim 17, wherein for the periodic TRS resource, if the QCL configuration is not provided, the UE derives the QCL assumption for the periodic TRS resource according to at least one of the followings:
the UE assumes that the QCL assumption for the periodic TRS resource is provided by a synchronization signal (SS) and physical broadcast channel (PBCH) (SS/PBCH) block used to obtain a master information block (MIB);
the UE assumes that the QCL assumption for the periodic TRS resource has QCL-TypeC with the SS/PBCH block used to obtain the MIB and QCL-TypeD with the same SS/PBCH block when applicable;
the UE assumes that the QCL assumption for the periodic TRS resource is used to receive a message 2 (msg2) in a most recent successful physical random access channel (PRACH) transmission;
the UE assumes that the QCL assumption for the periodic TRS resource has the QCL-TypeD with a receive (Rx) spatial parameter used to receive a message 3 (msg3) in the most recent successful PRACH transmission;
the UE assumes that the QCL assumption for the periodic TRS resource is provided by a transmission configuration indicator state (TCI-state) or the QCL assumption configured to a control resource set (CORESET) #0;
the UE assumes that the QCL assumption for the periodic TRS resource is provided by the TCI-state with a lowest TCI-state ID configured in a serving cell for the UE;
the UE assumes that the QCL assumption for the periodic TRS resource is provided by the TCI-state configured to a CORESET with a lowest CORESET ID in the serving cell;
the UE assumes that the QCL assumption for the periodic TRS resource is provided by the TCI-state configured to the CORESET with the lowest CORESET ID in an active bandwidth part (BWP) of the serving cell;
the UE assumes that the QCL assumption for the periodic TRS resource is provided by the TCI-state configured to the CORESET with the lowest CORESET ID in a latest slot in which one or more CORESETs within the active BWP are monitored by the UE in the serving cell;
the UE assumes that the QCL assumption for the periodic TRS resource is provided by an activated TCI-state with a lowest ID among TCI-states activated for a physical downlink shared channel (PDSCH) transmission in the active BWP of the serving cell; or
the UE assumes that the QCL assumption for the periodic TRS resource is provided by the activated TCI-state corresponding to a lowest TCI codepoint among the TCI-states activated for the PDSCH transmission in the active BWP of the serving cell.

19. The base station of claim 17, wherein the QCL assumption for the periodic TRS resource is provided by a reference signal configured in the TCI-state configured to the CORESET with the lowest CORESET ID in the active BWP of the serving cell.

20. The base station of claim 17, wherein the QCL assumption for the periodic TRS resource is provided by a reference signal configured in the TCI-state configured to the CORESET with the lowest CORESET ID in the serving cell.
